(19) United States
(12) Patent Application Publication
(10) Pub. No.: US 2018/0210734 A1
(43) Pub. Date: Jul. 26, 2018

(54) METHODS AND APPARATUS FOR PROCESSING SELF-MODIFYING CODES

(71) Applicant: ALIBABA GROUP HOLDING LIMITED, George Town (KY)

(72) Inventor: Xiaowei JIANG, San Mateo, CA (US)

(73) Assignee: ALIBABA GROUP HOLDING LIMITED

(21) Appl. No.: 15/417,079

(22) Filed: Jan. 26, 2017

(51) Int. Cl. G06F 9/38; G06F 9/30

(52) U.S. Cl. CPC G06F 9/3802; G06F 9/30043; G06F 9/30058; G06F 9/3016

(57) ABSTRACT

A method of handling self-modifying codes is presented. The method is performed by computer processor and comprises: receiving a fetch block of instruction data from an instruction fetch buffer; before transmitting the fetch block of instruction data to a decoding unit of the computer processor, determining whether the fetch block includes instruction data of self-modifying codes; responsive to determining that the fetch block includes instruction data of self-modifying codes, transmitting a flush signal to reset one or more internal buffers of the computer processor.

### TECHNICAL FIELD

The present disclosure generally relates to the field of computer architecture, and more particularly, to a method and an apparatus for processing self-modifying codes.

### BACKGROUND

Self-modifying codes may refer to a set of computer codes that modifies itself while being executed by a computer processor. Self-modifying codes are widely used for run-time code generation (e.g., during Just-In-Time compilation). Self-modifying codes are also widely used for embedded applications to optimize memory usage during the execution of the codes, thereby improving code density.

FIG. 1 illustrates an example of self-modifying codes. FIG. 1 illustrates software codes 102 and 104, each of which includes a number of instructions that can be executed by a computer processor. Software codes 102 and 104 can be stored in different locations within a memory. For example, software codes 102 can be stored at a memory location associated with a label “old_code,” and software codes 104 can be stored at a memory location associated with a label “new_code.”

Software codes 102 include a self-modifying code section 106, which includes a “memcpy old_code, new_code, size” (memory copy) instruction and a “jmp old_code” (jump) branching instruction. The execution of the “memcpy” instruction of self-modifying code section 106 can cause the computer processor to acquire data from the “new_code” memory location, and store the acquired data at “old_code” memory location. After executing the “memcpy” instruction, at least a part of software codes 102 stored at the “old_code” memory location can be overwritten with software codes 104. Moreover, the execution of the “jmp old_code” branching instruction of self-modifying code section 106 also causes the computer processor to acquire and execute software codes stored at a target location, in this case the “old_code” memory location. As discussed above, the software codes at the “old_code” memory location have been updated with software codes 106. Therefore, at least a part of software codes 102 are modified as computer processor executes the software codes, hence the software codes are “self-modifying.”

To reduce the effect of memory access latency, a computer processor typically employs a pre-fetching scheme, in which the computer processor pre-fetches a set of instructions from the memory, and stores the pre-fetched instructions in an instruction fetch buffer. When the computer processor needs to execute an instruction, it can acquire the instruction from the instruction fetch buffer instead of from the memory. Instruction fetch buffer typically requires shorter access time than the memory. Using the illustrative example of FIG. 1, before the computer processor executes software codes 102, it may pre-fetch a number of instructions from the “old_code” memory location, store the instructions in the instruction fetch buffer, and then acquire the stored instructions from the instruction fetch buffer for execution. The computer processor can select a set of instructions for pre-fetching based on a certain assumption of the execution sequence of the instructions.

Self-modifying codes can create a pipeline hazard for the aforementioned pre-fetching scheme, in that the assumption of the execution sequence of the instructions, based on which a set of instructions are selected for pre-fetching, is no longer valid following the modification to the codes. As a result, the instruction fetch buffer may pre-fetch incorrect instructions and provide incorrect instructions for execution. This can lead to execution failure and add to the processing delay of the computer processor. Therefore, to ensure proper and timely execution of the modified software codes, the computer processor needs to be able to detect the modification of the software codes, and to take measures to ensure that the instruction fetch buffer pre-fetches a correct set of instructions after the software codes are modified.

### SUMMARY

Embodiments of the present disclosure provide a method for handling self-modifying codes, the method being performed by a computer processor and comprising: receiving a fetch block of instruction data from an instruction fetch buffer; before transmitting the fetch block of instruction data to a decoding unit of the computer processor, determining whether the fetch block includes instruction data of self-modifying codes; responsive to determining that the fetch block includes instruction data of self-modifying codes, transmitting a flush signal to reset one or more internal buffers of the computer processor.

Embodiments of the present disclosure also provide a system comprising a memory that stores instruction data, and a computer processor being configured to process the instruction data. The processing of the set of instructions comprises the computer processor being configured to: acquire a fetch block of the instruction data from an instruction fetch buffer; before transmitting the fetch block of instruction data to a decoding unit, determine whether the fetch block of the instruction data contain self-modifying codes; responsive to determining that the fetch block of the instruction data contain self-modifying codes, reset one or more internal buffers of the computer processor.

Embodiments of the present disclosure also provide a computer processor comprising: a branch prediction buffer configured to store a pairing between an address associated with a predetermined branching instruction and a target address of a predicted taken branch; an instruction fetch buffer configured to store instruction data prefetched from a memory according to the pairing stored in the branch prediction buffer; an instruction fetch unit configured to: receive a fetch block of instruction data from the instruction fetch buffer; before transmitting the fetch block of instruction data to a decoding unit of the computer processor, determine, based on information stored in at least one of the branch prediction buffer and the instruction fetch buffer, whether the fetch block includes instruction data of self-modifying codes; and responsive to determining that the fetch block includes instruction data of self-modifying codes, transmitting a flush signal to reset one or more internal buffers of the computer processor.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a diagram illustrating an example of self-modifying codes.

FIG. 2 is a schematic diagram illustrating a computer system in which embodiments of the present disclosure can be used.

FIGS. 3A-3B are diagrams illustrating potential pipeline hazards posed by self-modifying codes.

FIG. 4 is a schematic diagram illustrating exemplary pre-fetch state registers for detecting self-modifying codes, according to embodiments of the present disclosure.

FIG. 5 is a flowchart illustrating an exemplary method of handling self-modifying codes, according to embodiments of the present disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Embodiments of the present disclosure provide a method and an apparatus for handling self-modifying codes. With an embodiment of the present disclosure, instructions of self-modifying codes can be detected from pre-fetched instruction data, before the instruction data are forwarded for decoding and execution. As a result, the likelihood of identifying and executing incorrect instructions due to the aforementioned pipeline hazards caused by self-modifying codes can be mitigated. Moreover, corrective actions can also be taken when the pipeline hazards are detected before the pre-fetched instructions are decoded and executed, thereby incorrect decoding result can be prevented from propagating through the pipeline. As a result, proper and timely execution of the modified software codes can be ensured.

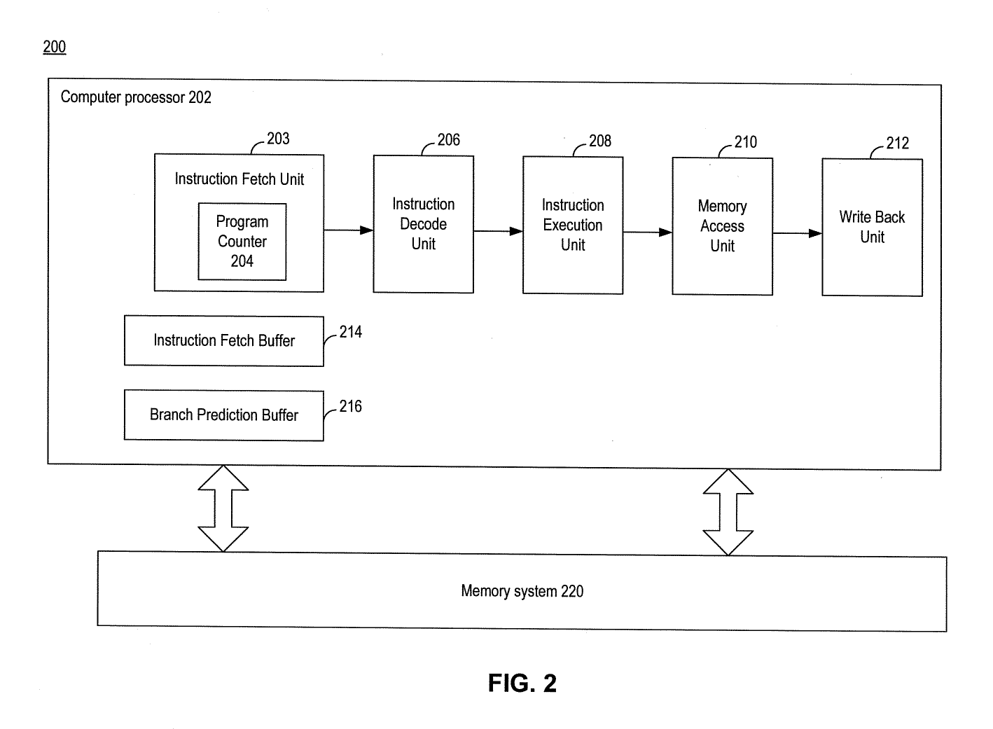

Reference is now made to FIG. 2, which illustrates a computer system 200 in which embodiments of the present disclosure can be used. As shown in FIG. 2, computer system 200 includes a computer processor 202 and a memory system 220 communicatively coupled with each other. Memory system 220 may include, for example, a cache and a dynamic random access memory (DRAM). Memory system 220 may store instructions that are executable by computer processor 202, as well as data to be processed when those instructions are executed. Both the instructions and the data are represented and stored in a binary format (ones and zeros) in memory system 220.

Computer processor 202 further includes a processing pipeline for acquiring and executing the instructions in stages. As shown in FIG. 2, the processing pipeline may include an instruction fetch unit 203, an instruction decode unit 206, an instruction execution unit 208, a memory access unit 210, and a write back unit 212. Computer processor 202 also includes an instruction fetch buffer 214 and a branch prediction buffer 216. In some embodiments, computer processor 202 may also include a controller (not shown in FIG. 2) configured to control and/or coordinate the operations of these units and buffers. Each of the units, buffers, and the controller, may include a set of combinational and sequential logic circuits constructed based on, for example, metal oxide semiconductor field effect transistors (MOSFET).

Instruction fetch unit 203 can acquire the instructions for execution in binary form and extract information used for decoding the instructions. The information may include, for example, a length of the instructions. In a case where the instructions have variable lengths (e.g., the instructions being a part of the Intel x86 instruction set), the instruction length information may be needed to identify the instructions. In some cases, the instruction length information can be determined based on the first byte of instruction data. As an illustrative example, if instruction fetch unit 203 identifies from the instruction data an escape byte, which is associated with the hexadecimal value of 0x0F, instruction fetch unit 203 may determine that at least the subsequent byte of data corresponds to an opcode, which may indicate that the instruction length is at least two bytes. Moreover, instruction fetch unit 203 may also extract different fields for an instruction, and based on the values of these fields, determine whether additional bytes are needed to determine the instruction length. As an illustrative example, for an Intel x86 instruction, instruction field unit 203 may extract the values for fields such as the Mod field and R/M field of the ModR/M byte, and based on the values of these fields, determine whether additional data (e.g., SIB byte) is needed to determine the instruction length.

Instruction fetch unit 203 can then transmit the information, including the instruction length, to instruction decode unit 206, which uses the information to identify the instruction. Based on an output of instruction decode unit 206, instruction execution unit 208 can then perform the operation associated with the instruction. Memory access unit 210 may also be involved in accessing data from memory system 220 and providing the data to instruction execution unit 208 for processing. Write back unit 212 may also be involved in storing a result of processing by instruction execution unit 208 in a set of internal registers (not shown in FIG. 2) for further processing.

The acquisition of an instruction by instruction fetch unit 203 can be based on an address stored in a program counter 204. For example, when computer processor 202 starts executing the first instruction of software codes 102, program counter 204 may store a value of 0x00, which is the memory address of the first instruction of software codes 102 (“xorl %eax, %eax). The program counter value can also be used for pre-fetching a set of instructions. For example, if the instructions are expected to be executed sequentially following the order by which they are stored in the memory system 220, instruction fetch unit 203 can acquire a set of consecutive instructions stored at a memory address indicated by program counter 204. Typically the set of instructions are pre-fetched in blocks of 4 bytes. After instruction fetch unit 203 acquires an instruction and finishes processing it (e.g., by extracting the instruction length information), the address stored in program counter can be updated to point to the next instruction to be processed by instruction fetch unit 203.

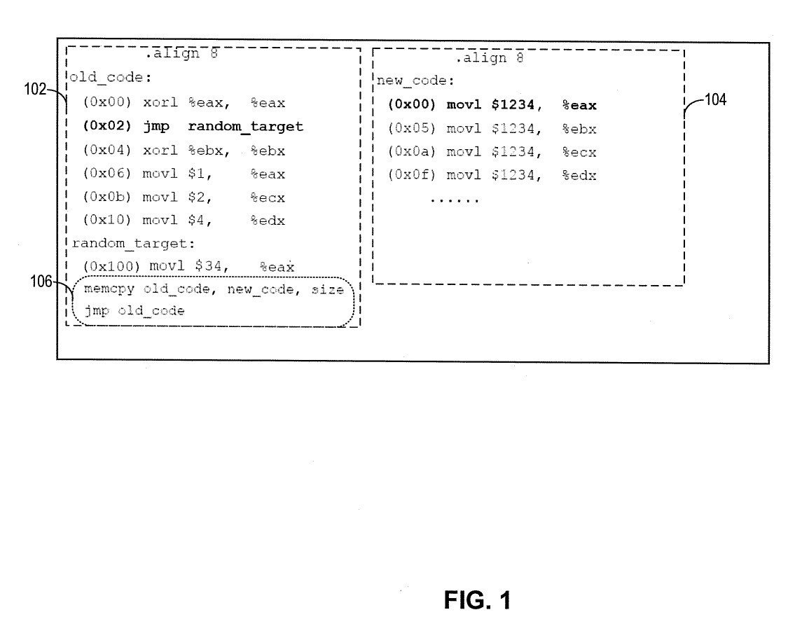

As an illustrative example, software codes 104 of FIG. 1 does not include any branching instructions, therefore the instructions are expected to be executed sequentially following the order by which they are stored in the memory system 220. In this case, instruction fetch unit 203 may pre-fetch a consecutive set of instructions, including the instructions stored at addresses 0x00 and 0x05.

On the other hand, if instruction fetch unit 203 has finished processing a branching instruction, instruction fetch unit 203 may perform a branch prediction operation, and pre-fetch a target instruction from a target location of the branching instruction, before the branching instruction is executed by instruction execution unit 208. As an illustrative example, referring to software codes 102 of FIG. 1, after instruction fetch unit 203 pre-fetches the “jmp random_target” instruction from the memory address 0x02, it can also pre-fetch a target instruction stored at the target location of the “jmp” instruction (“movl $34, %eax”), with the expectation that the target instruction will be executed following the execution of the branching instruction. Instruction fetch unit 203 can then store the pre-fetched instructions in instruction fetch buffer 104.

With such an arrangement, computer processor 202 does not need to wait until the execution of the branching instruction by instruction execution unit 208 to determine the target instruction, and the branching operation can be speeded up considerably.

Branch prediction buffer 216 can provide information that allows instruction fetch unit 203 to perform the aforementioned branch prediction operation. For example, branch prediction buffer 216 can maintain a mapping table that pairs an address of a fetched instruction with a target address. The address of the fetched instruction can be the address stored in program counter 204. The fetched instruction can be branching instruction, or an instruction next to a branching instruction. The target address can be associated with a target instruction to be executed as a result of execution of the branching instruction. The pairing may be created based on prior history of branching operations. As an illustrative example, computer processor 202 can maintain a prior execution history of software codes 102 of FIG. 1, and determine that based on the prior execution history, after execution of the “xorl %eax, %eax” instruction (followed by the “jmp” branching instruction), the instruction stored at the “random_target” memory location (“movl $34, %eax”) will be executed as well. Based on this history, branch prediction buffer 216 can maintain a mapping table that pairs the address of the “xorl” instruction (0x00) with the address of the “movl” address (0x100).

After instruction fetch unit 203 pre-fetches a first set of instructions based on the address stored in program counter 204, instruction fetch unit 203 can also access branch prediction buffer 216 to determine whether a pairing between the address and a target address exists. If such a pairing can be found, instruction fetch unit 203 may pre-fetch a second set of instructions including the target instruction from the target address. On the other hand, if such a pairing cannot be found, instruction fetch unit 203 can assume the instructions are to be executed sequentially following the order by which they are stored in memory system 220, and can pre-fetch a second set of consecutive instructions immediately following the first set of instructions. Instruction fetch unit 203 then stores the pre-fetched instructions in instruction fetch buffer 214, and then acquires the pre-fetched instructions later for processing and execution.

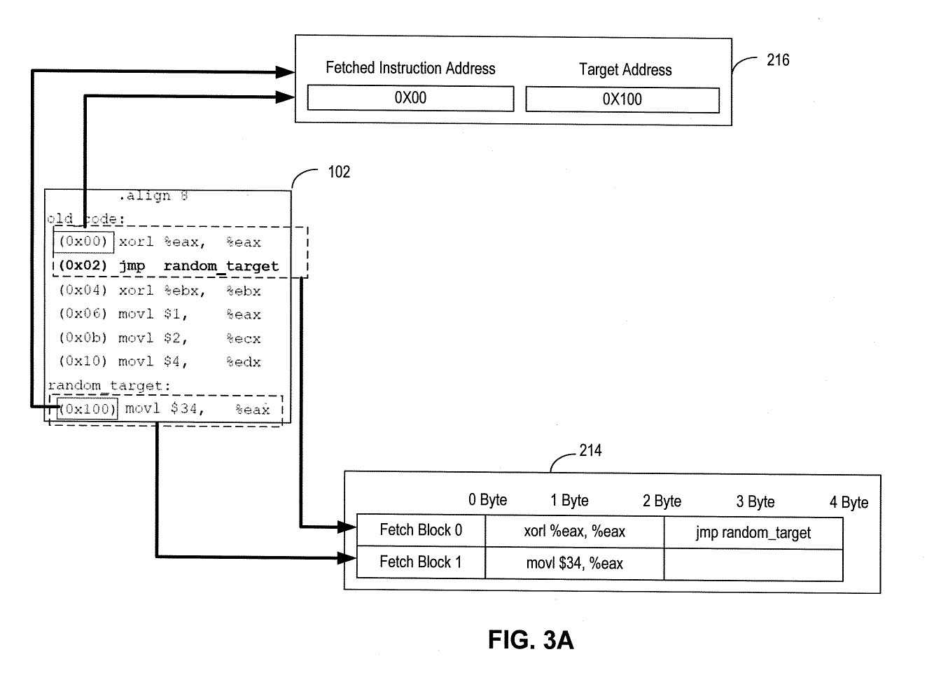

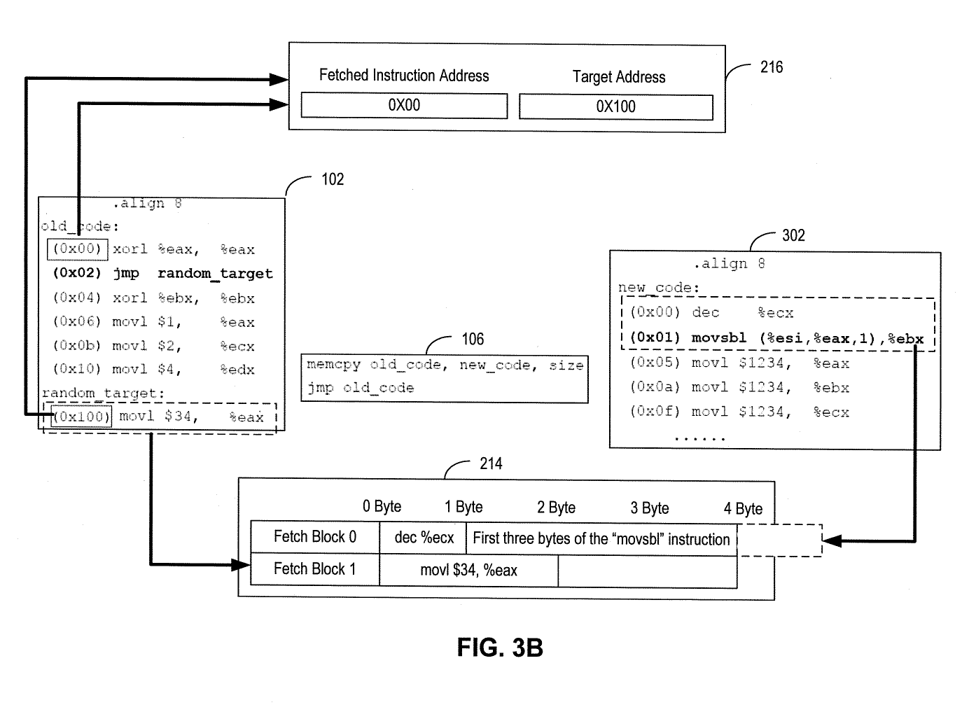

Despite the speed and performance improvement brought about by branch prediction and pre-fetching, self-modifying codes can pose potential pipeline hazards to these operations. Reference is now made to FIGS. 3A-3B, which illustrates a potential pipeline hazard posed by self-modifying codes. Referring to FIG. 3A, assuming that software codes 102 of FIG. 1, which includes a “jmp random_target” branching instruction, was executed by computer processor 200 earlier. As shown in FIG. 3A, branch prediction buffer 216 stores a pairing between a fetched instruction address (0x00) and a target address (0x100) that reflects the execution of the “jmp random_target” branching instruction of software codes 102. Based on the address stored in program counter 204, instruction fetch buffer 214 may acquire a 4-byte block of instruction data including the “xorl %eax, %eax” instruction and the “jmp random_target” instruction of software codes 102 from the 0x00 address of memory system 220, and store the data as fetch block 0. Moreover, based on the pairing information stored in branch prediction buffer 216, instruction fetch buffer 214 may also acquire a 4-byte block of instruction data from target address 0x100 (including the “movl $34, %eax” instruction) of software code 102, and store the data as fetch block 1. Instruction fetch unit 203 can then acquire fetch blocks 0 and 1 from instruction fetch buffer 214 instead of acquiring the instructions from memory system 220. Moreover, the rest of the processing pipeline of computer processor 202 can then decode the “xorl” instruction followed by the “jmp” instruction based on data from fetch block 0, and then decode the “movl” instruction based on data from fetch block 1 (and/or with other subsequent fetch blocks), without waiting for the execution of the “jmp” instruction.

In the illustrative example shown in FIG. 3A, fetch block 0 include complete data for every instruction included in the fetch block (the “xorl” and “jmp” instructions”), and none of fetch block 1 data is needed to decode these instructions in fetch block 0. This is typically the case if fetch block 1 includes a branch target of a branching instruction of fetch block 0. On the other hand, in a case where fetch block 1 is not fetched due to information from branch prediction unit 216, fetch block 0 and fetch block 1 likely store consecutive instructions, and data associated with an instruction in fetch block 0 can cross the fetch boundary and be included in fetch block 1. As an illustrative example, referring to software codes 302 of FIG. 3B, the “movsbl (%esi, %eax, 1), %ebx” instruction data has a 4-byte length, and may start from the end of the first byte of fetch block 0 and extend into the first byte of fetch block 1. In such a case, instruction fetch unit 203 may extract information (e.g., instruction length information) for decoding the “movsbl” instruction based on a combination of data of fetch block 0 and fetch block 1.

Referring to FIG. 3B, after the execution of the “memcpy” and “jmp” instructions of self-modifying code section 106, some of the software codes 102 stored at the “old_code” memory location are overwritten with software codes 302. Moreover, the address stored in program counter 204 is set to point to the “old_code” memory location. Instruction fetch unit 203 can then control instruction fetch buffer 214 to acquire a 4-byte block of instruction data starting from address 0x00 at memory system 220, and store the data in fetch block 0. The instruction data of the 4-byte block, at this point, can include the “dec %ecx” instruction and the first three bytes of the “movsbl” instruction data of software codes 302.

For fetch block 1, however, instruction fetch unit 203 may acquire a target address from the pairing stored in branch prediction buffer 216, and then control instruction fetch buffer 214 to acquire the instruction data from address 0x100 at memory system 220, instead of acquiring the instruction data from address location 0x04 for the remaining byte of the “movsbl” instruction data. As a result, as shown in FIG. 3B, fetch block 0 contains incomplete instruction data for the “movsbl” instruction, while fetch block 1 contains instruction data from software codes 102 and does not include any data for the “movsbl” instruction of software codes 302.

A pipeline hazard may occur in the scenario depicted in FIG. 3B when, for example, instruction fetch unit 203 obtains fetch block 0 and fetch block 1, and attempts to extract information of the “movsbl” instruction based on a combination of data from fetch block 0 and fetch block 1, when in fact fetch block 1 does not contains any data for the “movsbl” instruction. As an illustrative example, instruction fetch unit 203 may extract incorrect instruction length information based on a combination of data of fetch block 0 and fetch block 1, and provide the incorrect instruction length information to instruction decode unit 206. Based on the incorrect length information, instruction decode unit 206 may be unable to decode the instruction. As another illustrative example, instruction fetch unit 203 may extract correct instruction length information, but then instruction decode unit 206 incorrectly decodes the instruction data for “movsbl” based on data from fetch block 0 and fetch block 1, and misidentify the instruction data for another instruction. In both cases, computer processor 202 may perform incorrect operations due to the incorrect decoding result by instruction decode unit 206, or that multiple stages of the pipeline need to stop processing to allow the incorrect decoding result to be corrected. The performance of computer processor 202 can be substantially degraded as a result.

To mitigate the aforementioned pipeline hazards, computer processor 202 may need to remove the branch prediction decision that leads to the fetching of fetch blocks 0 and 1 (e.g., by removing the pairing stored in branch prediction buffer 216 shown in FIG. 2), to reflect that the prior branching operation is no longer valid after the software codes are modified. Computer processor 202 may also need to flush the pipeline by resetting various internal buffers (e.g., internal buffers of instruction fetch unit 203, instruction decode unit 206, and write back unit 212), etc., to avoid the incorrect decoding result being propagated through the pipeline.

On the other hand, if the fetch block 0 in FIG. 3B includes complete data for every instruction included in the fetch block, these instructions can be properly identified by instruction decode unit 206 based on fetch block 0 data. Therefore, any modification of the software codes in run-time does not necessarily lead to incorrect operation and processing by computer processor 202. For example, computer processor 202 may include additional branch resolution logics to determine, based on the correctly decoded instruction from fetch block 0, that branch prediction is improper, and that fetch block 1 was mistakenly acquired based on information from branch prediction buffer 216. In this case, fetch block 1 can be treated as wrong path instructions, and its data can be flushed from all stages of the pipeline, to maintain correct operation of computer processor 202. Moreover, if the instructions of fetch block 0 does not include a branch instruction, it is also not likely that fetch block 1 is fetched as a result of branch prediction. Therefore, the aforementioned pipeline hazard is also less likely to occur, and the modification of the software codes in run-time also does not necessarily lead to incorrect operation and processing by computer processor 202. In both cases, computer processor 202 may take no additional action and just process the fetch blocks.

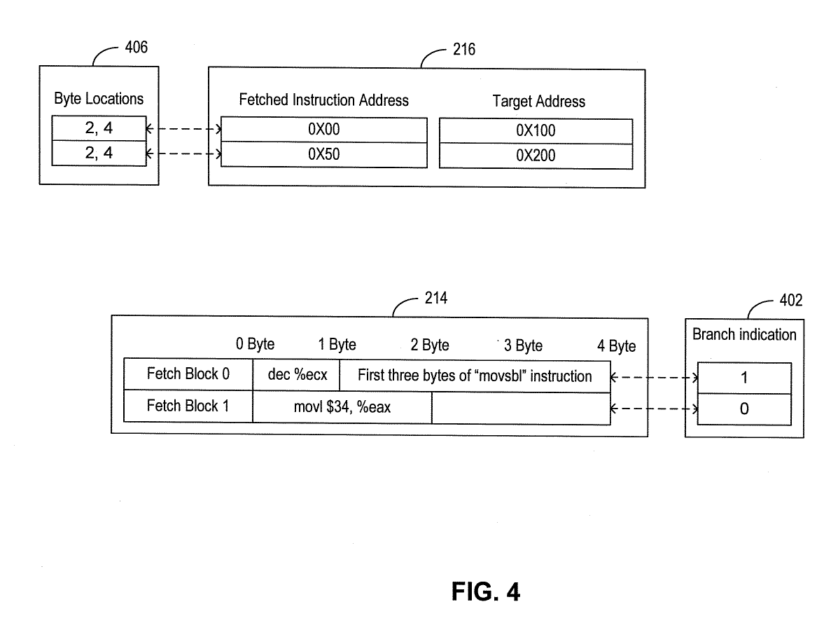

Reference is now made to FIG. 4, which illustrates exemplary pre-fetch state registers 402 and 404 according to embodiments of the present disclosure. In some embodiments, at least one of pre-fetch state registers 402 and 404 can provide an indication that a piece of software codes, the execution of which leads to a pairing between a fetched instruction address and a target address in a branch prediction buffer, has been updated as the software codes are executed. Based on this indication, computer processor 202 can perform the aforementioned actions including, for example, removing that pairing in the branch prediction buffer, performing a flush operation to reset some of the internal buffers of the computer processor (e.g., internal buffers of instruction fetch unit 203, instruction decode unit 206, and write back unit 212), etc., to ensure proper processing and execution of the self-modifying codes.

As shown in FIG. 4, in some embodiments, computer processor 202 may include a pre-fetch state register 402 configured to provide an indication that a fetch block includes a branching instruction and has a predicted taken branch. The indication can reflect that an address associated with the fetch block is paired with a target address associated with another fetch block in branch prediction buffer 216, both of which were pre-fetched from the memory according to the pairing.

In some embodiments, as shown in FIG. 4, pre-fetch state register 402 may store a set of branch indication bits, with each bit being associated with a fetch block in instruction fetch buffer 214. After pre-fetching fetch block 0, instruction fetch unit 203 may access branch prediction buffer 216, locate the pairing based on a fetched instruction address (e.g., based on program counter 204), and control instruction fetch buffer 214 to pre-fetch instruction data from the target address indicated by the pairing and store the pre-fetched data as fetch block 1. Instruction fetch unit 203 can then set the branch indication bit for fetch block 0 to “one” to indicate that it has a predicted branch (with target instruction included in fetch block 1). Although FIG. 4 illustrates that pre-fetch state register 402 as being separated from instruction fetch buffer 214, it is appreciated that pre-fetch state register 402 can be included in instruction fetch buffer 214.

When instruction fetch unit 203 accesses instruction fetch buffer 214 again to acquire fetch blocks 0 and 1 for processing, instruction fetch unit 203 may then determine, based on the indications provided by pre-fetch state register 402, that the software codes being processed have been modified. For example, if the branch indication bit of fetch block 0 is “one,” which indicates that it has a predicted taken branch, instruction fetch unit 203 may determine that the instructions in fetch block 0 includes a branch instruction. Based on this determination, instruction fetch unit 203 may also determine that fetch block 0 includes complete data for every instruction included in the fetch block, and that fetch block 1 should not include data for decoding any instruction in fetch block 0. Therefore, when extracting information of an instruction of fetch block 0, if instruction fetch unit 203 determines that some data from fetch block 1 is also needed to extract the information (e.g., to determine the instruction length) of the instruction, instruction fetch unit 203 may determine that fetch block 0 no longer includes a branching instruction with a target instruction in fetch block 1, contrary to what the associated branch indication bit indicates. Therefore, instruction fetch unit 203 may determine that the software codes are likely to have been modified. Based on this determination, instruction fetch unit 203 (or some other internal logics of computer processor 202) may transmit a signal to branch prediction buffer 216 to remove the pairing entry between address 0x00 and target address 0x100. The internal buffers of instruction fetch unit 203, instruction decode unit 206, write back unit 212, etc., can also be reset to ensure correct execution of the modified software codes.

On the other hand, if the branch indication bit of fetch block 0 is “zero,” which indicates that fetch block 0 does not have a predicted taken branch, instruction fetch unit 203 may determine that the fetch block 0 does not include a branch instruction. Therefore, instruction fetch unit 203 may determine that fetch blocks 0 and 1 likely contain consecutive instructions, and pipeline hazards are unlikely to occur, as explained above. Therefore, instruction fetch unit 203 does not need to take additional actions, and can just process fetch blocks 0 and 1 and provide the fetch block data to instruction decode unit 206 for decoding.

In some embodiments, computer processor 202 may also include a pre-fetch state register 404 configured to store the byte locations of a predetermined branching instruction (e.g., the “jmp” branching instruction). The byte locations may include, for example, a starting byte location, an ending byte location, etc., and can be associated with a fetched instruction address (and the associated target address) stored in branch prediction buffer 216. The byte locations can also be used to determine whether an instruction stored in a particular fetch block has been modified, which can also provide an indication that the piece of software codes being executed by computer processor 202 have been modified. Although FIG. 4 illustrates that pre-fetch state register 404 as being separated from branch prediction buffer 216, it is appreciated that pre-fetch state register 404 can be included in branch prediction buffer 216.

Referring to FIGS. 3A-3B and 4, the “jmp random_target” instruction of software codes 102 can have a starting byte location of 2 (based on the address location 0x02) and an ending byte location of 4 (based on the address location 0x04 of the instruction subsequent to the “jmp” instruction), which is represented as (2,4) in FIG. 4. The byte locations information can be stored in pre-fetch state register 404. When instruction fetch unit 203 accesses branch prediction buffer 216 and obtains the pairing of address 0x00 and target address 0x100, instruction fetch unit 203 also receives the associated byte locations (2, 4) from branch prediction buffer 216. When instruction fetch unit 203 extracts information of each instruction of fetch block 0, instruction fetch unit 203 may also determine the byte locations and the instruction lengths for the instructions. If instruction fetch unit 203 determines that none of the instructions of fetch block 0 has byte locations that match with the byte locations (2, 4), instruction fetch unit 203 may determine that the instructions stored in fetch block 0 has been modified, which can also indicate that the piece of software codes being executed by computer processor 202 have been modified. Based on this determination, instruction fetch unit 203 (or some other internal logics of computer processor 202) may then cause branch prediction buffer 216 to remove the pairing entry associated with the mismatching byte locations, and reset the internal buffers of instruction fetch unit 203, instruction decode unit 206, write back unit 212, etc., as discussed above.

In some embodiments, the detection of self-modifying codes can also be based on a combination of information provided by pre-fetch state registers 402 and 404. For example, pre-fetch state register 404 may only store the starting byte location of the predetermined branching instruction. Instruction fetch unit 203 may determine that an instruction of fetch block 0 is associated with a matching starting byte location, but its ending byte location (based on the extracted instruction length information) indicates that the instruction data extends into fetch block 1. If the branch indication bit (stored in pre-fetch state register 402) of fetch block 1 is “one,” which may indicate that fetch block 1 is fetched as a result of branch prediction and do not include any data of an instruction of fetch block 0, instruction fetch unit 203 may also determine that instructions stored in fetch block 0 has been modified, and that the piece of software codes being executed by computer processor 202 have been modified. The same determination can also be made if instruction fetch unit 203 determines that data from fetch block 1 is needed to determine the instruction length, and that the branch indication bit of fetch block 1 is “one,” as discussed above. Instruction fetch unit 203 may then reset its internal buffers, and transmit reset signals to internal buffers of instruction decode unit 206, and write back unit 212, etc., to avoid the incorrect decoding result being propagated through the pipeline.

With embodiments of the present disclosure, instructions of self-modifying codes can be detected from pre-fetched instruction data, before the instruction data are forwarded for decoding and execution. As a result, the likelihood of identifying and executing incorrect instructions due to the aforementioned pipeline hazards caused by self-modifying codes can be mitigated. Moreover, corrective actions can also be taken when the pipeline hazards are detected before the pre-fetched instructions are decoded and executed, thereby incorrect decoding result can be prevented from propagating through the pipeline. As a result, proper and timely execution of the modified software codes can be ensured.

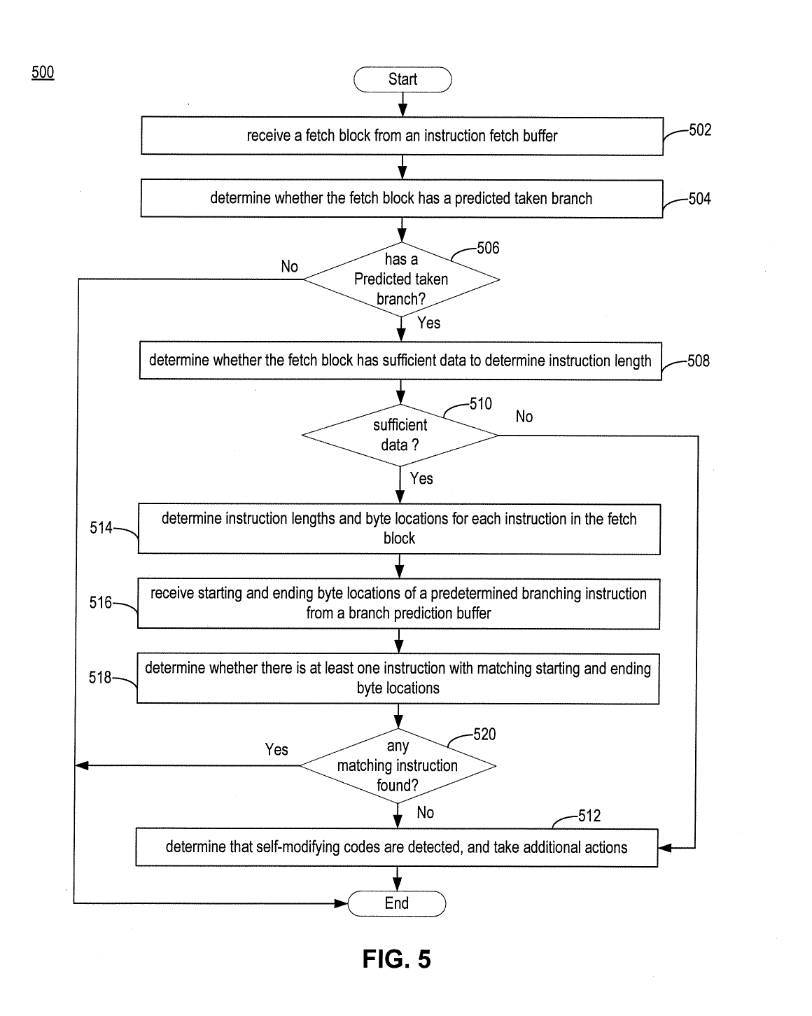

Reference is now made to FIG. 5, which illustrates an exemplary method 500 of processing self-modifying codes. The method can be performed by, for example, a computer processor, such as computer processor 202 of FIG. 2 that includes instruction fetch buffer 214, branch prediction buffer 216, and at least one of pre-fetch state registers 402 and 404 of FIG. 4. In some embodiments, the method can also be performed by a controller coupled with these circuits in computer processor 202.

After an initial start, method 500 proceeds to step 502, where computer processor 202 receive a fetch block of instruction data from instruction fetch buffer 214.

After receiving the fetch block, at step 504, computer processor 202 determines whether the fetch block has a predicted taken branch. The determination can be based on, for example, a branch indication bit of pre-fetch state register 402 associated with the fetch block. If computer processor 202 determines, in step 506, that the fetch block does not have a predicted taken branch, it can then determine that the fetch block is not associated with a branch prediction operation, and there is no need to take further action. Therefore, method 500 can then proceed to the end.

If computer processor 202 determines that the fetch block has a predicted taken branch (in step 506), it can then determine whether the fetch block has sufficient data for instruction length determination, in step 508. Instruction length determination can be based on the first byte of an instruction data, as well as the values of various fields of an instruction (e.g., ModR/M byte, SIB byte, etc.). As discussed above, in a case where the fetch block has a predicted branch, the fetch block should include complete data for every instruction included in the fetch block, and none of these instructions should extend into another fetch block that includes the branching target instruction. If computer processor 202 determines that the fetch block does not include sufficient data for instruction length determination, in step 510, it can proceed to determine that self-modifying codes are detected, and perform additional actions including, for example, removing a pairing entry from branch prediction buffer, flushing the internal buffers of computer processor 202, etc., in step 512.

If computer processor 202 determines that the fetch block includes sufficient data for instruction for instruction length determination (in step 510), computer processor 202 can proceed to determine instruction lengths and byte locations for each instruction in the fetch block, in step 514. In step 516. computer processor 202 can then receive the byte locations for a predetermined branching instruction in fetch block. As discussed above, the byte locations can include, for example, a starting byte location and an ending byte location of the predetermined branching instruction. Computer processor 202 may receive the byte locations information from, for example, pre-fetch state register 404.

After receiving the byte locations information from pre-fetch state register and determining the byte locations information of the instructions of the fetch block, computer processor 202 can then proceed to determine whether there is at least one instruction of the fetch block with starting and ending byte locations that match those of the predetermined branching instruction, in step 518. If the computer processor 202 determines that no instruction of the fetch block has the matching starting and ending byte locations (in step 520), which can indicate that the data of at least one instruction extends beyond the fetch block and cannot be the predetermined branching instruction, it can then proceed to step 512 and determine that the instruction of the fetch block has been modified, and self-modifying codes are detected. On the other hand, if an instruction with matching starting and ending byte locations (or just matching ending byte locations) is found in step 520, computer processor 202 may determine that either the software codes being executed are not self-modifying codes, or that the fetch block includes complete data for the instructions, and can proceed to the end without taking additional actions. Computer processor 202 may also discard a subsequent instruction (if any) to the predetermined branching instruction in the fetch block, because of the branch prediction operation.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method of handling self-modifying codes, the method being performed by a computer processor and comprising:
receiving a fetch block of instruction data from an instruction fetch buffer;
before transmitting the fetch block of instruction data to a decoding unit of the computer processor, determining whether the fetch block includes instruction data of self-modifying codes;
responsive to determining that the fetch block includes instruction data of self-modifying codes, transmitting a flush signal to reset one or more internal buffers of the computer processor.

2. The method of claim 1, wherein the determining whether the fetch block includes instruction data of self-modifying codes comprises:
determining whether the fetch block is associated with a predicted taken branch in a second fetch block;
responsive to determining that the fetch block is associated with a predicted taken branch:
determining whether the fetch block includes complete data for every instruction included in the fetch block;
responsive to determining that the fetch block includes incomplete data for at least one instruction, determining that the fetch block includes instruction data of self-modifying codes.

3. The method of claim 2, wherein determining whether the fetch block is associated with a predicted taken branch in a second fetch block comprises:
receiving a branch indication bit associated with the fetch block; and
determining whether the fetch block is associated with a predicted taken branch in a second fetch block based on the branch indication bit.

4. The method of claim 2, wherein the determining whether the fetch block includes complete data for every instruction included in the fetch block comprises:
determining whether the fetch block includes sufficient data for determining an instruction length for every instruction included in the fetch block.

5. The method of claim 2, wherein the determining whether the fetch block includes instruction data of self-modifying codes comprises:
responsive to determining whether the fetch block includes complete data for every instruction included in the fetch block:
receiving a byte location of a predetermined branching instruction, the byte location being associated with a pairing between an address associated with the predetermined branching instruction and a target address of the predicted taken branch;
determining whether one instruction of the fetch block is associated with a byte location that matches with the byte location of the predetermined branching instruction;
responsive to determining that no instruction of the fetch block is associated with a byte location that matches with the byte location of the predetermined branching instruction, determining that the fetch block includes instruction data of self-modifying codes.

6. The method of claim 5, wherein the byte location of the predetermined branching instruction includes an end byte location.

7. The method of claim 5, wherein the pairing is stored in a branch prediction buffer; wherein the method further comprises:
responsive to determining that the fetch block includes instruction data of self-modifying codes, removing the pairing from the branch prediction buffer.

8. A system comprising:
a memory that stores instruction data; and
a computer processor being configured to process the instruction data; wherein the processing of the set of instructions comprises the computer processor being configured to:
acquire a fetch block of the instruction data from an instruction fetch buffer;
before the transmission of the fetch block of instruction data to a decoding unit, determine whether the fetch block of the instruction data contain self-modifying codes;
responsive to determination that the fetch block of the instruction data contain self-modifying codes, reset one or more internal buffers of the computer processor.

9. The system of claim 8, wherein the determination of whether the fetch block of the instruction data contains self-modifying codes comprises the computer processor being configured to:
determine whether the fetch block is associated with a predicted taken branch in a second fetch block;
responsive to the determination that the fetch block is associated with a predicted taken branch:
determine whether the fetch block includes complete data for every instruction included in the fetch block;
responsive to the determination that the fetch block includes incomplete data for at least one instruction, determine that the fetch block includes instruction data of self-modifying codes.

10. The system of claim 9, wherein the instruction fetch buffer includes a branch indication bit associated with the fetch block; wherein the determination of whether the fetch block is associated with a predicted taken branch in a second fetch block comprises the computer processor being configured to:
receive the branch indication bit from the instruction fetch buffer; and
determine whether the fetch block is associated with a predicted taken branch in a second fetch block based on the branch indication bit.

11. The system of claim 9, wherein the determination of whether the fetch block includes complete data for every instruction included in the fetch block comprises the computer processor being configured to:
determine whether the fetch block includes sufficient data for determining an instruction length for every instruction included in the fetch block.

12. The system of claim 9, wherein the determination of whether the fetch block includes instruction data of self-modifying codes comprises the computer processor being configured to:
responsive to the determination that the fetch block includes complete data for every instruction included in the fetch block:
receive a byte location of a predetermined branching instruction, the byte location being associated with a pairing between an address associated with the predetermined branching instruction and a target address of the predicted taken branch;
determine whether one instruction of the fetch block is associated with a byte location that matches with the byte location of the predetermined branching instruction;
responsive to the determination that no instruction of the fetch block is associated with a byte location that matches with the byte location of the predetermined branching instruction, determine that the fetch block includes instruction data of self-modifying codes.

13. The system of claim 12, wherein the byte location of the predetermined branching instruction includes an end byte location.

14. The system of claim 12, wherein the computer processor further comprises a branch prediction buffer that stores the pairing and the byte location; wherein the computer processor is configured to:
responsive to the determination that the fetch block includes instruction data of self-modifying codes, remove the pairing from the branch prediction buffer.

15. A computer processor comprising:
a branch prediction buffer configured to store a pairing between an address associated with a predetermined branching instruction and a target address of a predicted taken branch;
an instruction fetch buffer configured to store instruction data prefetched from a memory according to the pairing stored in the branch prediction buffer;
an instruction fetch unit configured to:
receive a fetch block of instruction data from the instruction fetch buffer;
before the transmission of the fetch block of instruction data to a decoding unit of the computer processor, determine, based on information stored in at least one of the branch prediction buffer and the instruction fetch buffer, whether the fetch block includes instruction data of self-modifying codes;
responsive to the determination that the fetch block includes instruction data of self-modifying codes, transmitting a flush signal to reset one or more internal buffers of the computer processor.

16. The computer processor of claim 15, wherein the instruction fetch buffer includes a branch indication bit associated with the fetch block; wherein the determining whether the fetch block includes instruction data of self-modifying codes comprises the instruction fetch unit being configured to:
receive the branch indication bit from the instruction fetch buffer; and
determine whether the fetch block is associated with a predicted taken branch in a second fetch block based on the branch indication bit.

17. The computer processor of claim 16, wherein the determining whether the fetch block includes instruction data of self-modifying codes comprises the instruction fetch unit being configured to:
responsive to the determination that the fetch block is associated with a predicted taken branch in the second fetch block:
determine whether the fetch block includes sufficient data for determining an instruction length for every instruction included in the fetch block;
responsive to the determination that the fetch block does not include sufficient data for determining an instruction length for every instruction included in the fetch block, determine that the fetch block includes instruction data of self-modifying codes.

18. The computer processor of claim 15, wherein the branch prediction buffer associates a byte location of a predetermined branching instruction with the pairing; wherein the determining whether the fetch block includes instruction data of self-modifying codes comprises the instruction fetch unit being configured to:
determine whether one instruction of the fetch block is associated with a byte location that matches with the byte location of the predetermined branching instruction;
responsive to the determination that no instruction of the fetch block is associated with a byte location that matches with the byte location of the predetermined branching instruction, determine that the fetch block includes instruction data of self-modifying codes.

19. The computer processor of claim 18, wherein the byte location of the predetermined branching instruction includes an end byte location.

20. The computer processor claim 15, wherein the instruction fetch unit is further configured to:
responsive to the determination that the fetch block includes instruction data of self-modifying codes, remove the pairing from the branch prediction buffer.
